(19) United States
(12) Patent Application Publication
(10) Pub. No.: US 2018/0156146 A1
(43) Pub. Date: Jun. 7, 2018

(54) SYSTEM AND METHOD OF HEAT MANAGEMENT FOR VEHICLE

(71) Applicants: Hyundai Motor Company, Seoul (KR); Kia Motors Corporation, Seoul (KR)

(72) Inventors: Han Sang KIM, Ansan-si (KR); Jungjoo PARK, Gunpo-si (KR); Choo Saeng CHOI, Seongnam-si (KR)

(73) Assignees: Hyundai Motor Company, Seoul (KR); Kia Motors Corporation, Seoul (KR)

(21) Appl. No.: 15/662,145

(22) Filed: Jul. 27, 2017

(30) Foreign Application Priority Data
Dec. 7, 2016 (KR) 10-2016-0165929

(51) Int. Cl. F02D 41/06; F02N 19/10

(52) U.S. Cl. CPC F02D 41/068; F02D 2200/021; F02D 41/064; F02N 19/10

(57) ABSTRACT

A system of heat management of a vehicle may include a cooling line in which coolant cooling an engine flows therethrough; an exhaust heat retrieving apparatus for retrieving heat of exhaust gas discharged from a combustion chamber of the engine through operation fluid; a heat storage apparatus which stores heat of exhaust gas retrieved by the exhaust heat retrieving apparatus using the operation fluid and includes phase change material; a coolant heat exchanger in which heat stored in the heat storage apparatus and the coolant are heat-exchanged; a driving information detector for detecting a driving information including a temperature of the coolant and a temperature of the phase change material; and a controller for controlling the temperature of the coolant through the exhaust heat retrieving apparatus or the heat storage apparatus based on the temperature of the coolant and the temperature of the phase change material when the vehicle starts.

### CROSS-REFERENCE TO RELATED APPLICATION

The present application claims priority to Korean Patent Application No. 10-2016-0165929 filed on Dec. 7, 2016, the entire contents of which is incorporated herein for all purposes by this reference.

### BACKGROUND OF THE INVENTION

### Field of the Invention

The present invention relates to a system and a method of heat management of a vehicle.

### Description of Related Art

Generally, some of heat generated in a combustion chamber of an engine is transferred to a cylinder head, a cylinder block, a piston, and the like.

When a temperature of these components is excessively increased, thermal deformation is generated in the respective components formed of a metal material or an oil film of a cylinder inner wall is damaged, such that a thermal fault that a lubrication action between the piston and the cylinder block deteriorates occurs.

This thermal fault phenomenon of the engine generates abnormal combustion such as a combustion defect, knocking, pre-ignition, or the like, of the engine, decreases thermal efficiency, and decreases an output of the engine.

To the contrary, when a temperature of a coolant of the engine is excessively decreased, an output of the engine and fuel consumption are decreased. Therefore, there is a need to appropriately control the temperature of the coolant.

Particularly, at the time of cold start of the engine such as winter, viscosity of engine oil is increased, such that an output and efficiency of the engine are decreased, thereby decreasing fuel consumption. In addition, since a temperature of the combustion chamber is low, an excessive amount of exhaust gas is emitted due to incomplete combustion.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system of heat management of a vehicle that can improve engine output and efficiency by rapidly increasing a temperature of a coolant of the engine at the time of start of the engine.

Further, various aspects of the present invention are directed to providing a system of heat management of a vehicle that can improve fuel consumption of a vehicle by differently controlling coolant temperature based on a driving region of an engine.

A system of heat management of a vehicle according to an exemplary embodiment of the present invention may include a cooling line in which coolant cooling an engine flows; an exhaust heat retrieving apparatus for retrieving heat of exhaust gas discharged from a combustion chamber of the engine through operation fluid; a heat storage apparatus which stores heat of exhaust gas retrieved by the exhaust heat retrieving apparatus using the operation fluid and includes phase change material; a coolant heat exchanger in which heat stored in the heat storage apparatus and the coolant are heat-exchanged; a driving information detector for detecting a driving information including a temperature of the coolant and a temperature of the phase change material; and a controller for controlling the temperature of the coolant through the exhaust heat retrieving apparatus or the heat storage apparatus based on the temperature of the coolant and the temperature of the phase change material when the vehicle starts.

The exhaust heat retrieving apparatus may include an exhaust heat exchanger disposed in an exhaust line through which exhaust gas exhausted from the combustion chambers flows; a retrieving line in which the operation fluid flows between the exhaust heat exchanger and the heat storage apparatus; and a retrieving valve disposed in the retrieving line.

The exhaust heat retrieving apparatus may further include a storage line which is disposed between a PCM housing storing the phase change material and the coolant heat exchanger and the operation fluid flows; and a storage valve disposed in the storage line.

The controller may control that the operation fluid and the coolant are heat-exchanged in the coolant heat exchanger by opening the storage valve when the temperature of the phase change material is higher than the temperature of the coolant and a difference between the temperature of the phase change material and the temperature of the coolant is equal or greater than a predetermined temperature.

The controller may control that the exhaust gas and the operation fluid are heat-exchanged in the exhaust heat exchanger by opening the retrieving valve when the temperature of the coolant is higher than the temperature of the phase change material and a difference between the temperature of the phase change material and the temperature of the coolant is equal or greater than a predetermined temperature.

The controller may control the retrieving valve to be opened until the temperature of the phase change material reaches a charging temperature when the temperature of the phase change material reaches the temperature of the coolant.

The controller may differently control the temperature of the coolant based on a driving region by controlling the exhaust heat retrieving apparatus and the heat storage apparatus when the temperature of the coolant reaches a warm-up temperature.

The controller may control the exhaust heat retrieving apparatus and the heat storage apparatus such that the temperature of the coolant maintains a low load predetermined temperature when the driving region is a low load region, the temperature of the coolant maintains a middle load predetermined temperature when the driving region is a middle load region, and the temperature of the coolant maintains a high load predetermined temperature when the driving region is a high load region.

The low load predetermined temperature may be higher than the middle load predetermined temperature, and the middle load predetermined temperature may be higher than the high load predetermined temperature.

A method of heat management of a vehicle including an engine, an exhaust heat retrieving apparatus, a coolant heat exchanger and a heat storage apparatus according to another exemplary embodiment of the present invention may include detecting, by a driving information detector, a driving information including a temperature of a coolant for cooling the engine, a temperature of a phase change material of the heat storage apparatus, an engine torque and an engine speed when the engine starts, comparing, by a controller, the temperature of the phase change material to the temperature of the coolant; and controlling, by the controller, the temperature of the coolant based on the temperature of the phase change material and the temperature of the coolant by controlling the exhaust heat retrieving apparatus and the heat storage apparatus.

The controlling may include opening a storage valve of the heat storage apparatus until the temperature of the phase change material reaches the temperature of the coolant when the temperature of the phase change material is higher than the temperature of the coolant and a difference between the temperature of the phase change material and the temperature of the coolant is equal or greater than a predetermined temperature.

The controlling may include opening a retrieving valve of the exhaust heat retrieving apparatus until the temperature of the coolant reaches a warm-up temperature when the temperature of the coolant is higher than the temperature of the phase change material and a difference between the temperature of the phase change material and the temperature of the coolant is equal or greater than a predetermined temperature.

A retrieving valve of the exhaust heat retrieving apparatus may be opened until the temperature of the phase change material reaches a charging temperature.

The method may further include determining, by the controller, a driving region of the engine when the temperature of the coolant reaches a warm-up temperature; and differently controlling, by the controller, the temperature of the coolant based on the driving region of the engine by controlling the exhaust heat retrieving apparatus and the heat storage apparatus.

The exhaust heat retrieving apparatus and the heat storage apparatus may be controlled such that the temperature of the coolant maintains a low load predetermined temperature when the driving region is a low load region, the temperature of the coolant maintains a middle load predetermined temperature when the driving region is a middle load region, and the temperature of the coolant maintains a high load predetermined temperature when the driving region is a high load region.

The low load predetermined temperature may be higher than the middle load predetermined temperature, and the middle load predetermined temperature may be higher than the high load predetermined temperature.

According to an exemplary embodiment of the present invention, since coolant temperature is adjusted through an exhaust heat retrieving apparatus and a heat storage apparatus, a temperature of engine coolant is rapidly increase at a start of an engine and thus engine output and efficiency can be improved.

Further, coolant temperature is differently controlled based on a driving region through an exhaust heat retrieving apparatus and a heat storage apparatus, such that fuel consumption of a vehicle is improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a system of heat management of a vehicle according to an exemplary embodiment of the present invention.

FIG. 2 is a schematic view illustrating a system of heat management of a vehicle according to another exemplary embodiment of the present invention.

FIG. 3 is a block diagram illustrating a system of heat management of a vehicle according to an exemplary embodiment of the present invention.

FIG. 4 and FIG. 5 are flowcharts illustrating a method of heat management of a vehicle according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A description for contents that are not associated with the present invention will be omitted to clearly describe the present invention, and like reference numerals designate like elements throughout the specification.

In addition, since sizes and thicknesses of the respective components were arbitrarily shown in the accompanying drawings for convenience of explanation, the present invention is not limited to contents shown in the accompanying drawings. In addition, thicknesses were exaggerated to obviously represent several portions and regions.

Hereinafter, a system of heat management of a vehicle according to an exemplary embodiment of the present invention will be described in detail with reference to the accompanying drawings.

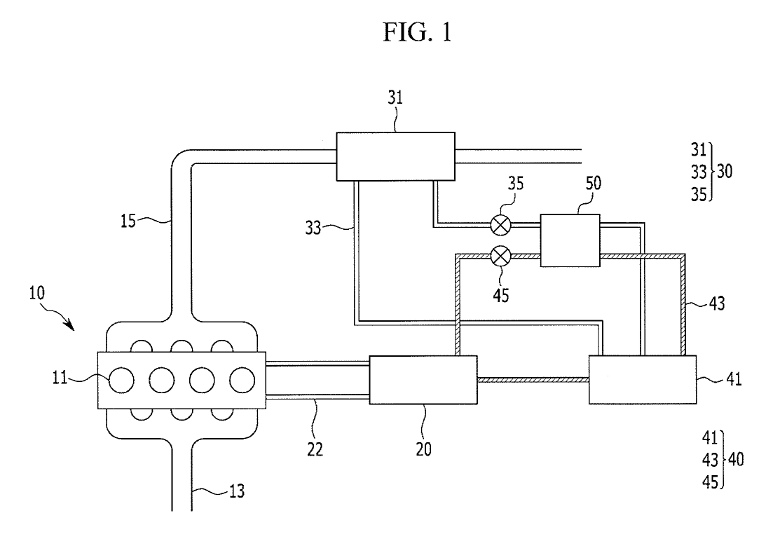

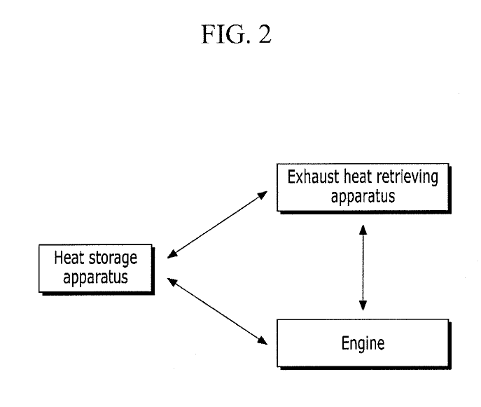

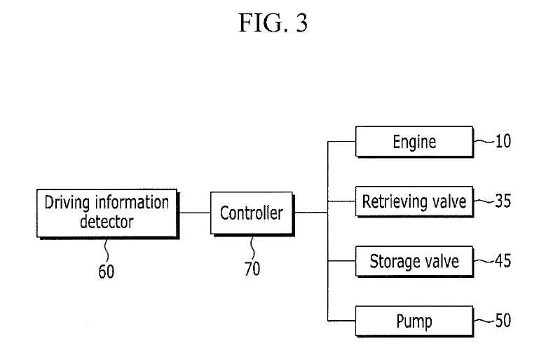

FIG. 1 is a schematic view illustrating a system of heat management of a vehicle according to an exemplary embodiment of the present invention. FIG. 2 is a schematic view illustrating a system of heat management of a vehicle according to another exemplary embodiment of the present invention.

As shown in FIG. 1 and FIG. 2, a system of heat management of a vehicle according to an exemplary embodiment of the present invention includes an engine 10, an exhaust heat retrieving apparatus 30 and a heat storage apparatus 40.

The engine 10 includes a plurality of combustion chambers 12 generating driving force by combustion of fuel. The engine 10 is provided with an intake line 13 through which intake gas supplied to the combustion chambers flows, and an exhaust line 15 through which exhaust gas exhausted from the combustion chambers 12 flows.

The engine 10 provided with a cooling line 22 through which coolant for cooling the engine 10 flows. The coolant flowing into the cooling line 22 is cooled passing through a radiator, and a coolant heat exchanger 20 is disposed in the cooling line 22. The coolant may be used by mixing antifreeze fluid and water.

The exhaust heat retrieving apparatus 30 retrieves heat included in exhaust gas exhausted from the combustion chamber 11 of the engine 10 through an operation fluid.

For this, the exhaust heat retrieving apparatus 30 includes an exhaust heat exchanger 31 disposed in the exhaust line 15, a retrieving line 33 through which the operation fluid flows between the exhaust heat exchanger 31 and the heat storage apparatus 40, and a retrieving valve 35 disposed in the retrieving line 33 and selectively block flow of the operation fluid. The retrieving valve 35 is operated by control signal of a controller 70 to be described below. The operation fluid may be used an 100% antifreeze fluid which a boiling point is over Celsius 140 degrees or oil.

The heat storage apparatus 40 temporarily stores heat included in exhaust gas discharged from the engine 10 through heat-exchange between the coolant of the engine and the operation fluid of the exhaust heat retrieving apparatus 30.

For this, the heat storage apparatus 40 includes a PCM housing 41 storing a phase change material (PCM), and a storage line 43 through which the operation fluid flows by being disposed between the PCM housing 41 and the coolant heat exchanger 20, and a storage valve 45 disposed in the storage line 43 and selectively blocking flow of the operation fluid.

The storage valve 45 is operated by control signal of the controller 70. The operation fluid may be used an 100% antifreeze fluid which a boiling point is over Celsius 140 degrees or oil.

The operation fluid flowing into the storage line 43 and the coolant flowing into the cooling line 22 are heat-exchanged in the coolant heat exchanger 20 such that the temperature of the coolant can be increased.

The operation fluid flowing into the retrieving line 33 and the exhaust gas are heat-exchange in the exhaust heat exchanger 31 of the exhaust heat retrieving apparatus 30, and heat transferred through the operation fluid flowing into the retrieving line 33 is stored in the phase change material of the PCM housing 41. The phase change material may store heat of about Celsius 120-140 degrees.

A pump 50 (e.g., electric water pump 50) may be disposed in the storage line 43 and the retrieving line 33. The operation fluid flowing into the retrieving line and the storage line is pumped by the pump 50.

When the retrieving valve 35 is opened, the operation fluid flows into the retrieving line 33 passing through the exhaust heat exchanger 31 and the PCM housing 41. At this time, the operation fluid retrieving heat of the exhaust gas in the exhaust heat exchanger 31 increases the temperature of the phase change material.

When the storage valve 45 is opened, the operation fluid flows into the storage line 43 passing through the coolant heat exchanger 20 and the PCM housing 41. At this time, the coolant and the operation fluid are heat-exchanged in the coolant heat exchanger 31, and the temperature of the coolant is increased or decreased.

The system of heat management of the vehicle according to an exemplary embodiment of the present invention further includes a driving information detector 60 detecting a driving information of the vehicle, and a controller 70 controlling the temperature of the coolant based on the driving information.

The driving information may include a temperature of the coolant, a temperature of the phase change material, an engine torque and an engine speed. The driving information detector 60 may include temperature sensor for detecting temperature of the coolant and the phase change material, a torque sensor detecting the engine torque and a speed sensor (e.g., crank speed sensor) detecting the engine speed. The driving information is transmitted to the controller 70.

The controller 70 adjusts the temperature of the coolant by controlling the exhaust heat retrieving apparatus 30 and the heat storage apparatus 40 based on the driving information.

For this, the controller 70 may be implemented by one or more processors operated by a predetermined program, in which the predetermined program is set to perform steps of a method of heat management of the vehicle according to an exemplary embodiment of the present invention.

Hereinafter, the method of heat management of the vehicle according an exemplary embodiment of the present invention will be described in detail with reference to accompanying drawings.

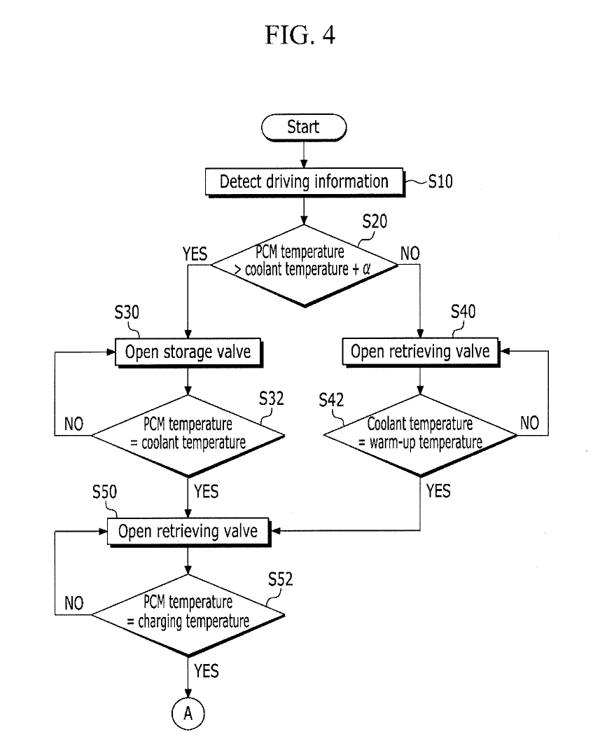

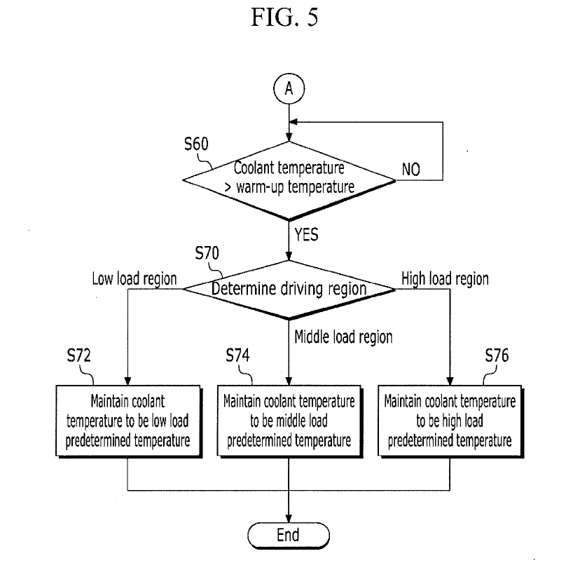

FIG. 4 and FIG. 5 are flowcharts illustrating a method of heat management of a vehicle according to an exemplary embodiment of the present invention.

Referring to FIG. 4 and FIG. 5, when the engine 10 starts, the driving information detector 60 detects the driving information including the coolant for cooling the engine, the temperature of the phase change material of the heat storage apparatus, the engine torque and the engine speed at step S10, the driving information is transmitted to the controller 70.

The controller 70 compares the temperature of the phase change material to the temperature of the coolant at step S20.

When the temperature of the phase change material is higher than the temperature of the coolant by a predetermined temperature a (e.g., Celsius 5 degrees), the controller 70 opens the storage valve 45 at step S30. Accordingly, the operation fluid flowing into the storage line 43 and the coolant flowing into the cooling line 22 are heat-exchanged in the coolant heat exchanger 20, and thus the temperature of the coolant may be increased.

That is, since the temperature of the coolant is rapidly increased at an initial starting of the engine by use of the heat storage apparatus 40, engine output and engine efficiency may be improved.

When the temperature of the phase change material reaches the temperature of the coolant, the controller 70 controls the retrieving valve 35 to be opened such that exhaust heat retrieved through the operation fluid is stored in the phase change material until the temperature of the phase change material reaches a charging temperature at step S52

In the step S20, when the temperature of the coolant is higher than the temperature of the phase change material by a predetermined temperature a (e.g., Celsius 5 degrees), the controller 70 opens the retrieving valve 35 at step S40. Accordingly, the temperature of the phase change material is increased by retrieving heat of the exhaust gas.

The controller 70 determines whether the temperature of the coolant reaches a warm-up temperature (e.g., Celsius 85 degrees) at step S42. When the temperature of the coolant reaches the warm-up temperature, it is possible to determine that the engine warm-up is completed.

When the engine is warmed up, the method proceeds to the step S50.

The controller 70 determines whether the temperature of the coolant is higher than the warm-up temperature at step S60. That is, the controller 70 determines whether the warm-up of the engine is completed.

When the warm-up of the engine is completed, the controller 70 determines a driving region of the engine 10 from the driving information detected by the driving information detector 60 at step S70. The driving region of the engine 10 may be determined from the engine torque and the engine speed.

The controller 70 adjusts the temperature of the coolant based on the driving region of the engine 10.

When the driving region of the engine 10 is a low load region, the controller 70 controls that the temperature of the coolant maintains a low load predetermined temperature (e.g., Celsius 105 degrees) by use of the exhaust heat retrieving apparatus 30 and the heat storage apparatus 40 at step S72.

For example, when the temperature of the coolant is lower than the low load predetermined temperature and the temperature of the phase change material is higher than the temperature of the coolant, the controller controls that the coolant and the operation fluid are heat-exchanged in the coolant heat exchanger by opening the storage valve until the temperature of the coolant reaches the low load predetermined temperature.

When the driving region of the engine 10 is a middle load region, the controller 70 controls that the temperature of the coolant maintains the middle load predetermined temperature (e.g., Celsius 95 degrees) by use of the exhaust heat retrieving apparatus 30 and the heat storage apparatus 40 at step S74. Here, the low load predetermined temperature is higher than the middle load predetermined temperature.

In the low load region and the middle load region, friction of the engine 10 is reduced and fuel consumption of the vehicle can be improved by increasing the temperature of the coolant.

When the driving region of the engine 10 is the high load region, the controller 70 controls that the temperature of the coolant maintains the high load predetermined temperature (e.g., Celsius 85 degrees) by use of the exhaust heat retrieving apparatus 30 and the heat storage apparatus 40 at step S76. Here, the middle load predetermined temperature is higher than the high load predetermined temperature.

In the high load region, since the engine 10 generates a lot of heat, there is a problem that knocking is occurred. Therefore, knocking can be prevented by decreasing the temperature of the coolant.

As described above, according to an exemplary embodiment of the present invention, since coolant temperature is adjusted through an exhaust heat retrieving apparatus and a heat storage apparatus, a temperature of engine coolant is rapidly increase at a start of an engine and thus engine output and efficiency can be improved.

Further, the temperature of the coolant is differently controlled based on the driving region of the engine, so fuel consumption of a vehicle is improved.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system of heat management of a vehicle comprising:
a cooling line in which coolant cooling an engine flows;
an exhaust heat retrieving apparatus for retrieving heat of the exhaust gas discharged from a combustion chamber of the engine through operation fluid;
a heat storage apparatus which is configured to store heat of exhaust gas retrieved by the exhaust heat retrieving apparatus using the operation fluid and includes phase change material (PCM);
a coolant heat exchanger in which heat stored in the heat storage apparatus and the coolant are heat-exchanged;
a driving information detector for detecting a driving information including a temperature of the coolant and a temperature of the phase change material; and
a controller configured for controlling the temperature of the coolant through the exhaust heat retrieving apparatus or the heat storage apparatus based on the temperature of the coolant and the temperature of the phase change material when the vehicle starts.

2. The system of claim 1, wherein the exhaust heat retrieving apparatus includes:
an exhaust heat exchanger disposed in an exhaust line through which the exhaust gas exhausted from the combustion chambers flows;
a retrieving line in which the operation fluid is configured to flow between the exhaust heat exchanger and the heat storage apparatus; and
a retrieving valve disposed in the retrieving line.

3. The system of claim 2, further including:
a storage line which is disposed between a PCM housing storing the phase change material and the coolant heat exchanger and the operation fluid is configured to flow therethrough; and
a storage valve disposed in the storage line.

4. The system of claim 3, wherein
the controller is configured to control that the operation fluid and the coolant are heat-exchanged in the coolant heat exchanger by opening the storage valve when the temperature of the phase change material is higher than the temperature of the coolant and a difference between the temperature of the phase change material and the temperature of the coolant is equal or greater than a predetermined temperature.

5. The system of claim 3, wherein
the controller is configured to control that the exhaust gas and the operation fluid are heat-exchanged in the exhaust heat exchanger by opening the retrieving valve when the temperature of the coolant is higher than the temperature of the phase change material and a difference between the temperature of the phase change material and the temperature of the coolant is equal or greater than a predetermined temperature.

6. The system of claim 4, wherein
the controller is configured to control the retrieving valve to be opened until the temperature of the phase change material reaches a charging temperature when the temperature of the phase change material reaches the temperature of the coolant.

7. The system of claim 4, wherein
the controller is configured to differently control the temperature of the coolant based on a driving region by controlling the exhaust heat retrieving apparatus and the heat storage apparatus when the temperature of the coolant reaches a warm-up temperature.

8. The system of claim 7, wherein
the controller is configured to control the exhaust heat retrieving apparatus and the heat storage apparatus, such that the temperature of the coolant maintains a low load predetermined temperature when the driving region is a low load region,
the temperature of the coolant maintains a middle load predetermined temperature when the driving region is a middle load region, and
the temperature of the coolant maintains a high load predetermined temperature when the driving region is a high load region.

9. The system of claim 8, wherein
the low load predetermined temperature is higher than the middle load predetermined temperature, and the middle load predetermined temperature is higher than the high load predetermined temperature.

10. A method of heat management of a vehicle including an engine, an exhaust heat retrieving apparatus, a coolant heat exchanger and a heat storage apparatus, the method comprising:
detecting, by a driving information detector, a driving information including a temperature of a coolant for cooling the engine, a temperature of a phase change material of the heat storage apparatus, an engine torque and an engine speed when the engine starts,
comparing, by a controller, the temperature of the phase change material to the temperature of the coolant; and
controlling, by the controller, the temperature of the coolant based on the temperature of the phase change material and the temperature of the coolant by controlling the exhaust heat retrieving apparatus and the heat storage apparatus.

11. The method of claim 10, wherein the controlling includes:
opening a storage valve of the heat storage apparatus until the temperature of the phase change material reaches the temperature of the coolant when the temperature of the phase change material is higher than the temperature of the coolant and a difference between the temperature of the phase change material and the temperature of the coolant is equal or greater than a predetermined temperature.

12. The method of claim 10, wherein the controlling includes:
opening a retrieving valve of the exhaust heat retrieving apparatus until the temperature of the coolant reaches a warm-up temperature when the temperature of the coolant is higher than the temperature of the phase change material and a difference between the temperature of the phase change material and the temperature of the coolant is equal or greater than a predetermined temperature.

13. The method of claim 11, wherein a retrieving valve of the exhaust heat retrieving apparatus is configured to be opened until the temperature of the phase change material reaches a charging temperature.

14. The method of claim 13, further including:
determining, by the controller, a driving region of the engine when the temperature of the coolant reaches a warm-up temperature; and
differently controlling, by the controller, the temperature of the coolant based on the driving region of the engine by controlling the exhaust heat retrieving apparatus and the heat storage apparatus.

15. The method of claim 14, wherein the exhaust heat retrieving apparatus and the heat storage apparatus are configured to be controlled such that the temperature of the coolant maintains a low load predetermined temperature when the driving region is a low load region,
the temperature of the coolant maintains a middle load predetermined temperature when the driving region is a middle load region, and
the temperature of the coolant maintains a high load predetermined temperature when the driving region is a high load region.

16. The method of claim 15, wherein
the low load predetermined temperature is higher than the middle load predetermined temperature, and the middle load predetermined temperature is higher than the high load predetermined temperature.
